(19) United States
(12) Patent Application Publication
(10) Pub. No.: US 2004/0179028 A1
(43) Pub. Date: Sep. 16, 2004

(54) Pixel defect correcting method, color mura correcting method and image display device

(75) Inventor: Hisao Arai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/796,269

(22) Filed: Mar. 10, 2004

(30) Foreign Application Priority Data
Mar. 12, 2003 (JP) P. 2003-066927
Mar. 12, 2003 (JP) P. 2003-066928

(51) Int. Cl. G09G 5/00

(52) U.S. Cl. 345/690

(57) ABSTRACT

In a pixel defect correct method, a refractive index varying area which is different in refractive index from the surroundings thereof in a plane parallel to an image display face is equipped on a defective pixel of the image display face and thereby light is scattered from the refractive index varying area, and the defective pixels of the image display are made inconspicuous. In a color mura correcting method, a color mura film is equipped to an image display portion of an image display device, the complementary color of the color mura is generated in the color mura correcting film in connection with the color mura of the display image, and thereby the color mura of the display device is made inconspicuous.

### BACKGROUND OF THE INVENTION

1. Field of the Invention

The present invention relates to a pixel defect correcting method for correcting a defective pixel of image display in an image display device such as a liquid crystal display or an organic EL display, and an image display device in which a defective pixel of image display is corrected. The present invention also relates to a color mura correcting method for correcting color irregularities occurring on a display image in an image display device such as a liquid crystal display device, an organic EL display or the like, and an image display device for correcting color irregularities of the display image.

2. Description of the Related Art

It is general in an image display device that many pixels are arranged on an image display face and each pixel is controlled to perform image display. Therefore, a pixel which does not work normally becomes a defective pixel such as a luminescent spot (the pixel is turned on at all times) or a black spot (the pixel is turned off at all times). For example, in a flat type image display device such as a liquid crystal display, an organic EL display or the like, switching elements (for example, TFT elements), etc. are integrated every pixel by micro-fabrication. Therefore, when dust is contaminated in a manufacturing process, a defect occurs in a mask pattern in a micro-fabrication process or a switching element itself has a defect, the pixel at that site does not normally work and thus it becomes a defective pixel. The total number of pixels in the overall pixel display device is extremely large. For example, the total number of pixels of a normal liquid crystal display is equal to about several hundreds of thousand to several millions, and thus some defect is liable to occur in no small measure.

These defective pixels are not negligible to human's eyes once a human views these defective pixels in image display, and thus an image display device in which some defective pixel occurs has no product value. As a result, the yield of products is reduced. In connection with increase in screen size and enhancement in definition of image display devices, there is a tendency that the number of pixels is increased or the pixels are made finer. As the number of pixels is increased or the pixels are made finer, the probability that defective pixels occur is increased, and thus the product yield is further reduced.

By removing factors causing the defective pixels carefully in the manufacturing process, it is possible in theory to beforehand prevent occurrence of defective pixels which causes reduction of the product yield. However, in order to implement this, a high equipment investment for an improvement of a clean room, etc. is needed, so that the manufacturing cost rises up.

Accordingly, as a countermeasure to defective pixels occurring in the manufacturing process, it is required to subject the image display device to some treatment to correct the defective pixels of image display so that the defective pixels are inconspicuous.

As a method of correcting defective pixels as described above are known a method of interrupting light transmission through the defective pixels by separating or short-circuiting electrodes relevant to the defective pixels in a liquid crystal display (for example, see JP-A-8-110527), a method of depressing the function of orientation film at the portions corresponding to the defective pixels with laser irradiation to thereby reduce light-transmittance of the portions (for example, JP-A-10-62734), etc. According to these methods, by utilizing the fact that the black-spot defect is more inconspicuous than the luminescent-spot defect, luminescent-spot defects are set to black-spot defects from which substantially no light is emitted, thereby making the luminescent-spot defects inconspicuous.

Furthermore, with respect to luminescent-spot defects, there has been proposed a method of equipping light-transmissible film on the image display face of an image display device in advance to reduce the light-transmittance of the portions corresponding to the defective pixels (for example, see JP-A-9-325332).

As described above, the defective pixels reduce the product yield, and thus the correction of the defective pixels is indispensable.

In addition, an image display device generally has various kinds of constituent elements. For example, FIG. 6 is a schematic cross-sectional view showing the typical construction of a liquid crystal display device as an image display device. The liquid crystal display device has such a structure that a liquid crystal cell achieved by filling liquid crystal 15 between a pair of substrates 12, 19 having transparent electrodes 13, 17 respectively is sandwiched between two polarizing plates 11, 20 as shown in FIG. 6. A color filter (RGB) 18 is disposed on a substrate 19 at the viewing side. Normally, the transparent electrodes 13, 17 are formed in a stripe form so as to be orthogonal to each other when viewed from the viewing side, and form pixels (corresponding to the cross areas of the transparent electrodes 13, 17) in combination with the color filter 18. As not shown, wires are drawn out from the transparent electrodes 13, 17 and connected to a driving circuit,-and the liquid crystal is adjusted every image, so that the image display can be performed.

As described above, in the image display device comprising many kinds of constituent elements, color irregularities are liable to occur in a display image by various factors such as dispersion in electrical characteristics such as driving voltage, etc. in driving circuits for pixels, etc., performance defectiveness of patterning of electrodes, etc. for pixel formation, polarizing plates, color filters and optical film such as various kinds of functional film, etc.

Uniformity of hue of a display image in the image display device directly affects the quality of the display image, and has an influence on the product performance of the device. Therefore, with respect to image display devices in which color irregularities corresponding to irregularities of hue occur, these devices are needed to be subjected to color-mura correction.

As a method of correcting color irregularities caused by the difference in brightness among pixels due to dispersion in characteristic among driving circuits or the like, is known a method of carrying out an interpolation operation on the basis of a reference point on an image display face to calculate a brightness correction value, and feeding back this value to the driving circuits to adjust the difference in brightness among the pixels, thereby correcting the color irregularities (for example, see JP-A-2001-142448).

Furthermore, as a method of correcting the color irregularities based on light shading caused by electrode patterns is known a method of adjusting the electrode width and the interval between the electrodes to reduce the difference in brightness between an electrode-equipped area and an no-electrode equipped area, thereby correcting the color irregularities (for example, see JP-A-2002-296613).

As described above, when the cause of the color irregularities such as the driving circuit characteristic, the electrode pattern or the like is apparent, various correction methods have been proposed. Furthermore, when the optical film itself has some defect, the color irregularities based on the defect could be prevented if a film having no defect is used.

However, with respect to some color irregularities caused by the optical film used in the image display device, even when the optical film itself has no defect and thus it does not induce any color irregularities by itself, occurrence of the color irregularities concerned is first detected through a visual estimation carried out after the optical film is mounted in the image display device in the case of a specific combination with another film or by an effect of a brightness distribution of emission light from the back side because the image display device comprises various kinds of constituent elements as shown in FIG. 6.

The color irregularities as described above can be estimated for the first time after they are mounted. Therefore, it is the present circumstances that it is difficult to present some index indicating which characteristic induces color irregularities as the characteristic of an individual optical film and also there is no effective solving means. Therefore, the products must be manufactured by trial and error and this is a factor reducing the production efficiency of the products.

### SUMMARY OF THE INVENTION

Accordingly, the present invention has an object to provide a pixel defect correcting method of making defective pixels occurring in an image display device inconspicuous on an image display, and an image display device in which the defective pixels on the image display are corrected.

The above object is achieved by providing, on a defective pixel of an image display face, a refractive index varying area which is different in refractive index from the surroundings thereof in a plane parallel to the image display face, that is, the above object is achieved by the following pixel defect correcting methods of (1) to (4) and image display devices of (5) to (8).

(1) A pixel defect correcting method for image display, the method comprising: equipping a refractive index varying area, which is different in refractive index from the surroundings thereof in a plane parallel to an image display face, on a defective pixel on the image display face.

(2) A pixel defect correcting method for image display, the method comprising: equipping a pixel defect correcting film on an image display face; and equipping a refractive index varying area, which is different in refractive index from the surroundings thereof in a plane parallel to the image display face, to a portion of the pixel defect correcting film which is located above a defective pixel.

(3) A pixel defect correcting method for image display, the method comprising: attaching an image defect correcting film having a refractive index varying area, which is different in refractive index from the surroundings thereof in a plane parallel to a film face, onto an image display face so that the refractive index varying area is located above a defective pixel.

(4) The pixel defect correcting method for image display according to any one of (1) to (3), wherein the refractive index is varied by irradiating a laser beam to thereby equip the refractive index varying area.

(5) An image display device, wherein a defective pixel of image display is substantially corrected by a refractive index varying area on an image display face which is different in refractive index from the surroundings thereof in a plane parallel to the image display face.

(6) An image display device comprising: a refractive index varying area which is different in refractive index from the surroundings thereof in a plane parallel to an image display face, the refractive index varying area being equipped above a defective pixel of the image display face.

(7) An image display device comprising: a pixel defect correcting film having a refractive index varying area, which is different in refractive index from the surroundings thereof in a plane parallel to an image display face, on the image display face, the refractive index varying area being located above a defective pixel of the image display face.

(8) The image display device according to (7), wherein the pixel defect correcting film comprises photochromic material.

The present invention, in view of the foregoing situation, has also an object to provide a color mura correcting method for properly correcting unforeseeable color irregularities even when color irregularities which are difficult to be estimated from individual constituent elements of the image display device occurring the display image, and an image display device in which the color irregularities of the display image can be corrected.

The above object is achievable by the color mura correcting methods of (9) to (11) and the image display devices of (12) and (13).

(9) A color mura correcting method comprising: equipping a color mura correcting film is equipped to an image display portion of an image display; and correcting a color mura of a display image by the color mura correcting film, wherein the complementary color of the color mura is generated in the color mura correcting film in accordance with the color mura of the display image.

(10) The color mura correcting method according to (9), comprising: equipping the color mura film with a refractive index varying structure which is periodically varied in refractive index and generates the complementary color of the color mura of the display image through light interference, whereby the complementary color of the color mura of the display image is generated in the color mura correcting film.

(11) The color mura correcting method according to (10), wherein the refractive index varying structure is equipped by irradiation of a laser beam.

(12) An image display device comprising: a color mura correcting film for generating a complementary color of a color mura of a display image in accordance with the color mura, the color mura correcting film being equipped to an image display portion.

(13) The image display device according to (12), wherein the color mura correcting film comprises a refractive index varying structure which is periodically varied in refractive index and generates the complementary color of the color mura of the display image through light interference.

That is, according to the present invention, the color mura correcting film is equipped to the image display portion of the image display device, and the complementary color of the color mura concerned is generated in the color mura correcting film in connection with the color mura of the display image, whereby the color mura to be viewed can be made inconspicuous.

The above relationship will be described with reference to FIG. 2 schematically showing the section of the image display portion of the image display device. As shown in FIG. 2, in the image display device, an image is normally formed on a viewing side surface 3 of a pixel array 2 containing RGB pixels arranged. The image thus formed is viewed from the view point 0 of an observer through an image display portion 1 achieved by laminating a glass substrate, a protection film, an optical film, etc.

According to this invention, a color mura correcting film 4 is equipped to the image display portion 1, and the complementary color Lc of a color mura Li is generated at the site 5 of the color mura correcting film 4 which corresponds to the color mura Li of a display image. Color deviation of the color mura Li from a normal color Lr is substantially offset by the complementary color Lc thus generated, and thus a color Lr′ which is very near to the normal color Lr is viewed from the view point 0 of the observer. Therefore, the color mura Li can be made inconspicuous.

### BRIEF DESCRIPTION OF THE DRAWINGS

FIG. 1 is a schematic cross-sectional view of a display side surface site of an imaged is play device which schematically shows that a defective pixel is corrected by a refractive index varying area;

FIG. 2 is a schematic cross-sectional view of an image display portion of an image display device, which schematically shows that a color mura is corrected by occurrence of a complementary color;

FIG. 3 is a schematic cross-sectional view of the image display portion of the image display device, which schematically shows that a color mura is corrected by a refractive index varying structure;

FIG. 4 is a schematic diagram showing that light interferes in the refractive index varying structure;

FIGS. 5A and 5B show an example of the refractive index varying structure; and

FIG. 6 is a schematic cross-sectional view showing a typical construction of a liquid crystal display device.

### DETAILED DESCRIPTION OF THE INVENTION

A first embodiment of the present invention will be described hereunder in detail.

According to this embodiment, the refractive index varying area, which is different in refractive index from the surroundings thereof in a plane parallel to an image display face and equipped on at least a defective pixel of the image display face, can make the defective pixel inconspicuous.

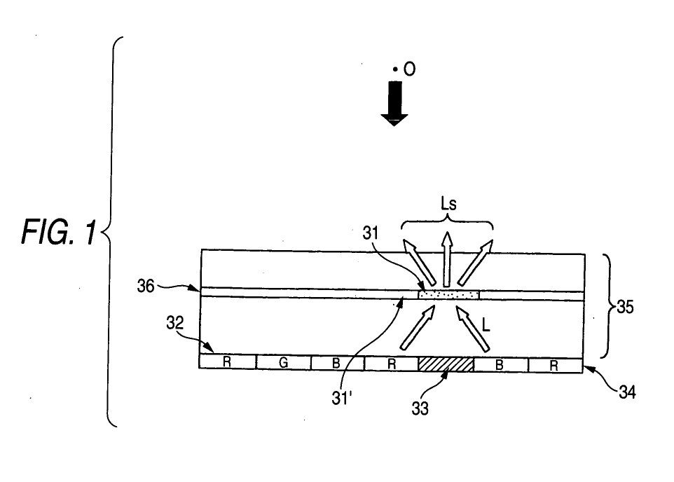

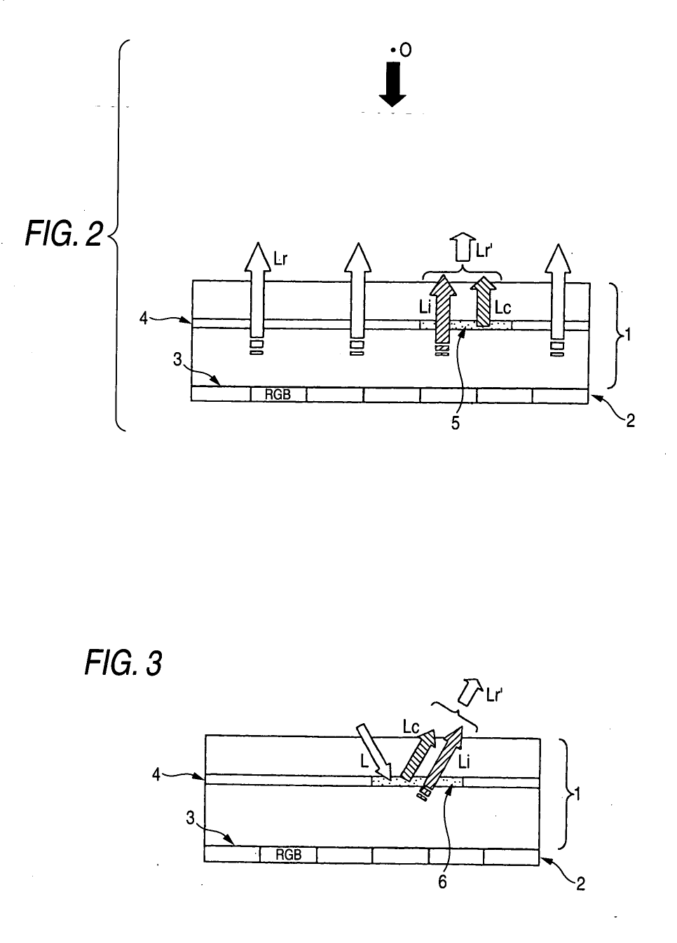

This principle will be described with reference to FIG. 1 which is a schematic cross-sectional view of an image display side surface site of the image display device.

As shown in FIG. 1, in the image display device, pixels of RGB (red, green, blue) are normally arranged, and an image display face 32 is formed on the surface of a pixel array 34. Normally, a surface site 35 formed by attaching a glass substrate, a protection film, an optical film, etc. is further formed on the image display face 32.

In this embodiment, a refractive index varying area 31 is equipped above a defective pixel 33. The refractive index varying area 31 is defined as an area whose refractive index is varied to be different from the refractive index of the surroundings 31′ thereof in a plane 36 parallel to the image display face 32. Therefore, light incident to the refractive index varying area 31 is scattered due to the difference in refractive index from the surroundings 31′. Normally, the refractive index of the areas other than the parallel plane 36 in the surface site 35 is substantially equal to that of the surroundings 31′, and has a difference in refractive index from the refractive index varying area 31.

When the refractive index varying area 31 is equipped above the defective pixel 33, the defective pixel 33 is not directly viewed from the view point 0 of an observer observing the image display, but scattering light Ls scattering in the refractive index varying area 31 is viewed. As a result, the defective pixel 33 in the image display is made inconspicuous.

Even when the defective pixel 33 is a black-spot defect which is turned off at all times, a part of light L emitted from other pixels is incident to the refractive index varying area 31 and scatters there although no light is emitted from the defective pixel 33. Therefore, the defective pixel 33 is made inconspicuous even when the defective pixel 33 is a black-spot defect.

The distance between the parallel plane 36 -having the refractive index varying area 31 and the image display face 32 in the image display device is not to a specific value. The parallel plane 36 may be equipped at any position of the surface site 35 formed on the image display face 32.

The view point 0 of the observer observing the image display is normally disposed at a distance of several tens centimeters to several meters from the image display face 32, however, the refractive index varying area 31 exists at a distance of several μm at maximum from the image display face 32 even when it is located at any position of the surface site 35 in the image display device. Accordingly, the distance of the refractive index varying area 31 from the image display face 32 is sufficiently smaller than the distance of the view point 0 of the observer from the image display face 32, and thus the variation of the refractive index varying area 31 does not particularly affect the correction effect of the defective pixel of the present invention.

The parallel plane 36 having the refractive index varying area 31 may be separately equipped as a pixel defect correcting layer, or as any other functioning layer constituting the surface site 35 of the image display device. That is, the pixel defect correcting film may be equipped on the image surface and the refractive index varying area 31 may be equipped to the pixel defect correcting film. Alternatively, the refractive index varying area 31 may be equipped to a functional film such as another optical film, protection film or the like or an adhesive layer therefor.

When the refractive index varying area 31 is equipped to the pixel defect correcting film, the pixel defect correcting film is equipped on the image display face in advance, and the refractive index varying area 31 is equipped at a portion of the pixel defect correcting film which is located above the defective pixel 33. After the refractive index varying area 31 is equipped to the pixel defect correcting film in advance, the pixel defect correcting film may be attached onto the image display face so that the refractive index varying area 31 is located above the defective pixel 33.

Normally, plural defective pixels 33 exit in the image display device. If the total number of defective pixels appearing in an image display is reduced to some extent, the rate at which the defective pixels are conspicuous in the whole image display would be reduced, and thus the defective pixels in the image display are substantially corrected. Normally, if the refractive index varying area 31 is equipped on each of defective pixels 33 whose number is preferably equal to 50% or more of the total number of defective pixels. It is favorable to achieve a more excellent correcting effect that the refractive index varying area 31 is equipped on each of defective pixels 33 which is equal to 80% or more, more preferably on each of all the defective pixels 33.

Furthermore, the refractive index varying area 31 may be equipped on normally-operating pixels other than the defective pixels 33, however, the equipment degree of the refractive index varying area 31 is preferably equal to 20% or less of the total number of normal pixels, more preferably 10% or less.

The difference in refractive index between the refractive index varying area 31 and the surroundings 31′ thereof in the parallel plane 36 may be set to any value in the range that light can be scattered to correct the defective pixels. In order to achieve the correction effect of the defective pixels, the refractive index difference may be set to a smaller value as the size of the pixel is smaller. For example, for a pixel having a size of 300 μm to 400 μm in square, the refractive index difference is preferably set to 0.03 to 0.20, and for a pixel having a size of 100 μm to 300 μm in square, the refractive index difference is preferably set to 0.01 to 0.15.

The refractive index varying area 31 may be formed of a single area having an uniform refractive index, or formed of the mixture of a minute area having a higher refractive index and a minute area having a lower refractive index to make scattering occur more easily.

As a method of equipping the refractive index varying area 31 in the parallel plane 36 is known a method of applying a physical or chemical action on the refractive index of a desired area and setting this area to a refractive rate varying area. For example, the desired area is locally heated, or light, an electron beam or a particle beam is irradiated to the desired area to partially decompose, degenerate or crystallize the constituent material to vary the refractive index. Furthermore, the constituent material may be degenerated by using a local chemical reaction.

Of these methods, the method of irradiating light, particularly, a laser beam is preferable because the refractive index of the desired area can be more easily varied, and the refractive index can be varied in a minute area.

In the case of the laser-beam irradiation, plural laser beams having high intensity (0.1 to 100 kW) and a narrow pulse width (100 to 1000 fs) are used, and these laser beams are irradiated with being focused to degenerate the constituent material of the irradiation area through multiphoton reaction, whereby the refractive index can be varied. A two-photon reaction using two laser beams is preferable because it is convenient.

According to the present invention, as the method of bringing the refractive index variation may be used as a method described by D. A. Parthenopoulos et al. “Three-dimensional optical storage memory”, Science Vol. 245 (1989) p. 843, D. A. Akimov et al., Jpn. J. Appl. Phys., vol. 36 (1997) p. 426.

In the case of the method of using plural laser beams, the refractive index variation is brought in only a minute area to which the plural laser beams are focused, and, a refractive index varying area in which many refractive-index varying minute domains are distributed can be formed by using this method.

Any material whose refractive index is varied by each method described above may be used for the parallel plane 36 to form the refractive index varying area 31. This material is not particularly limited. A photochromic material is preferably used because it is easily degenerated by light irradiation and the refractive index can be varied by this degeneration.

Spiropyran-based material, fulgid-based material, diarylethene-based material or the like is used as the photochromic material.

As described above, in this embodiment, a pixel defect correcting film can be used to equip the refractive index varying area 31.

The pixel defect correcting film contains a layer for correcting pixel defect (pixel defect correcting layer) as the parallel plane 36 having the refractive index-varying area 31, and may contain a support material or other layers as occasion demands. The pixel defect correcting film is preferably formed by providing the pixel defect correcting layer on the support material.

The material constituting the pixel defect correcting layer may be organic material or inorganic material insofar as the refractive index varying area 31 can be formed in this layer. Particularly, the photochromic material described above is preferable.

The pixel defect correcting layer may be formed on the support material by a well-known vapor deposition method or coating method.

Polystyrene, polycarbonate, polysulfone, polyether sulfone or the like may be used as the main component of the support material of the pixel defect correcting film.

As the image display device used in this invention may be used a liquid crystal display, an organic EL display, a plasma display, a CRT display, etc. In any pixel display device, the defective pixels of the image display can be corrected by equipping the refractive index varying area on the defective pixels.

A second embodiment of the present invention will be described hereunder in detail.

A color mura correcting film used in this embodiment has a mechanism for generating the complementary color of a color mura at the site corresponding to the color mura of a display image. As the mechanism for generating the complementary color of the color mura may be used a refractive index varying structure in which the complementary color of the color mura occurs with light interference.

By equipping a refractive index varying structure 6 at the site corresponding to the color mura Li of the color mura correcting film 4 as shown in FIG. 3, the complementary color Lc of the color mura Li is formed by making external light L interfere in the refractive index varying structure 6, so that the color mura Li is corrected to be inconspicuous.

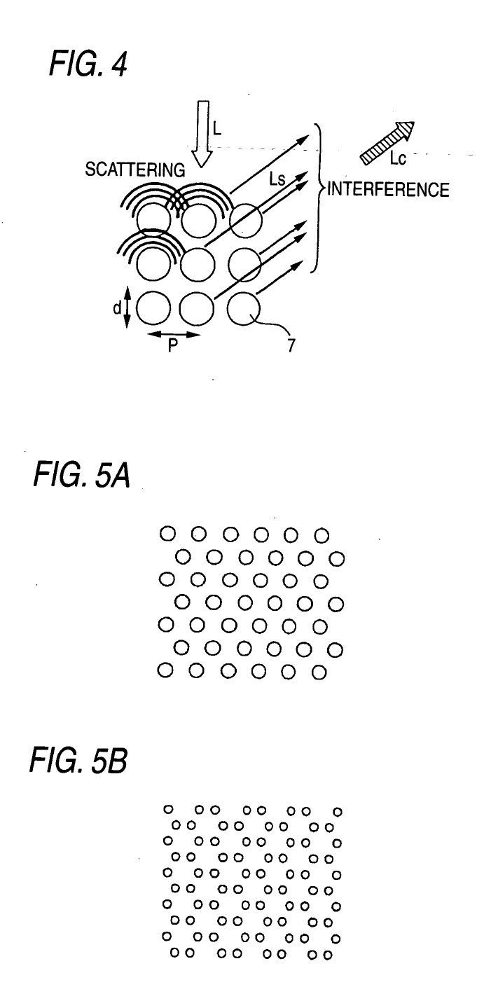

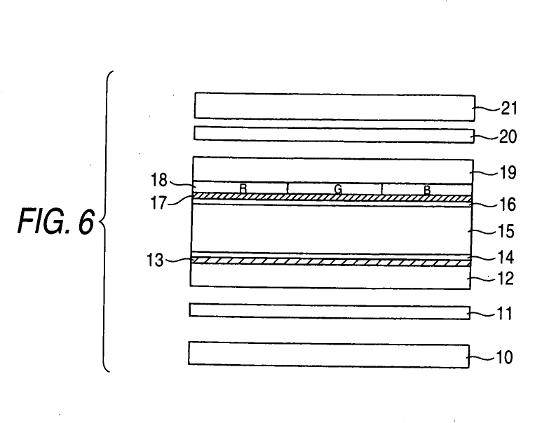

FIG. 4 is a schematic diagram showing an example of the refractive index varying structure 6. The refractive index varying structure 6 shown in FIG. 4 is designed so that minute balls 7 are periodically arranged and the refractive index is periodically varied in connection with the arrangement of the minute balls 7. The arrangement of the minute balls 7 may be three-dimensionally expanded. The external light L incident to the refractive index varying structure is scattered by each minute balls 7, and scattered light beams Ls thus scattered interfere with one another, whereby light having a specific wavelength is emitted. The wavelength of the emission light is varied on the basis of the period P of the arrangement of the minute balls 7 and the diameter d of each minute ball, and light having the complementary color Lc of the color mura can emitted by adjusting the period P and the diameter d.

The arrangement period P and the diameter d of the minute balls 7 are preferably set to be shorter than the wavelengths of light in the visible band because light having the complementary color Lc of the color mura is more easily generated by the scattering/interference process described above. Specifically, the arrangement period P is preferably set to 200 to 1000 nm. The diameter dispreferably set to 100 to 1000 nm. Furthermore, the shape of the minute ball 7 is not limited to a sphere insofar as it can serve to scatter the external light L as described above.

The arrangement of the minute balls 7 is not limited to a tetragonal-lattice arrangement as shown in FIG. 4, and it is not limited to a specific arrangement insofar as it can generate light having the complementary color Lc of a color mura. For example, as shown in FIG. 5, a trigonal-lattice arrangement (FIG. 5A), a hexagonal-lattice arrangement (FIG. 5B), etc. are used.

The difference in refractive index between each minute ball 7 and the medium in the refractive index varying structure 6 is set to the extent that the external light L is scattered by the minute balls 7, and it is preferably set to about 1.1 to 2.0.

When the refractive index varying structure 6 is equipped to the color mura correcting film 4, the color mura correcting film 4 is equipped to the image display portion of the image display device in advance, and the refractive index varying structure 6 is equipped to the site of the color mura correcting film 4 which corresponds to the color mura of the display image. Alternatively, after the refractive index varying structure 6 is equipped to the color mura correcting film 4 in advance, the color mura correcting film 4 may be attached to the image display portion so that the refractive index varying structure 6 covers the color mura Li of the display image.

Light irradiation, particularly, irradiation of a laser beam is preferable as means of equipping the refractive index varying structure 6 in the color mura correcting film 4. The irradiation of the laser beam can vary the refractive index in only an area to which the laser beam is focused, and thus it is preferable to equip a minute structure. For example, plural laser beams are used and irradiated onto the color mura correcting film 4 with being focused so that the constituent material of an irradiation area is degenerated through a multi-photon reaction (simultaneous absorption reaction of many photons by reacting molecules) to vary the refractive index. The refractive index varying structure 6 can be equipped by moving the laser irradiation area little by little.

Photo-polymerization or photo-bridging is available as the degeneration of the constituent material of the irradiation area, and polymerization or bridging can be easily induced by using photo-polymerizable or photo-bridgeable compositions as the constituent material of the color mura correcting film and irradiating laser beams to these materials.

A laser having any wavelength band of visible band, near-infrared band, infrared band, etc. can be used as a laser beam source in accordance with the kind of material to be degenerated. The pulse width of the laser beams to be irradiated is preferably equal to about femto second level.

The method of manufacturing the microstructure through the photo-polymerizing or photo-bridging reaction using the multi-photon absorption reaction is disclosed in detail in JP-T-2002-512260, and thus the method disclosed in this publication may be also applied to this invention.

The material constituting the color mura correcting film is not particularly limited and it may be an organic compound or inorganic compound insofar as it has a function of generating the complementary color of the color mura. As described above, photo-polymerizable or photo-bridgeable compositions which is photo-polymerized or photo-bridged and varies in refractive index by irradiation of laser beams are preferably used.

Epoxy resin, polyimide resin, phenol resin, tetrafluoroethylene polymer, BT resin, benzocyclobutene or the like is used as the photo-polymerizable or photo-bridgeable compound used for the photo-polymerizable or photo-bridgeable composition.

A photo-polymerization initiator is preferably added in the composition, and a well-known material may be used as the initiator.

A filler may be further added in the composition. The filler to be added is preferably formed of inorganic minute particles, and it may be formed of inorganic minute particles of silicon dioxide, alumina, calcium oxide, barium sulfate, talc, kaolin, calcium sulfate, titan dioxide, zirconium oxide, tin oxide, ITO, zinc oxide or the like.

In the image display portion of the image display device, the color mura correcting film 4 maybe equipped at any position, however, it is preferably equipped on the viewing side surface of the image display portion.

Furthermore, by equipping the refractive index varying structure 6 in functional film such as other optical film, protection film or the like or in an adhesive layer thereof, they are brought with the function of the color mura correcting film 4.

A liquid crystal display, an organic EL display, a plasma display, a CRT display or the like may be used as the image display device used in this invention. In any image display device, the color mura correcting film is equipped to the image display portion to generate the complementary color of the color mura, and the color mura of the display image can be corrected.

### EXAMPLES

The present invention will be described in more detail by the following examples, however, the present invention is not limited to these examples.

### Example 1

(Manufacturing of Pixel Defect Correcting Film)

Methylene chloride solution (15 wt % (mass%)) of polyether sulfone is flow-casted on a steel drum, and film is continuously peeled off and dried with suppressing drawing to achieve a support material film of 50 μm in thickness. 1 wt % solution of diarylethene (photochromic material) is coated on the support material film and then dried to equip a pixel defect correcting layer of 10 μm in thickness, thereby manufacturing a pixel defect correcting film.

(Correction of Defective Pixels of Display Image on Liquid Crystal Display)

A commercially-available liquid crystal display in which black spots based on defective pixels (pixel size of 300 μm×300 μm) occurs is prepared.

A beam having a wavelength of 760 nm (50 kW, pulse width 130 fs) of a titan-sapphire laser is irradiated to the pixel defect correcting layer of the pixel defecting correcting film thus manufactured so that diarylethene molecules are subjected to optical anisotropy to vary the refractive index in the laser-irradiated area, thereby equipping the refractive index varying area. The size of the refractive index varying area is set to about 100 μm×100 μm, and the difference in refractive index of the pixel defect correcting layer from the surroundings thereof is equal to about 0.05.

Subsequently, the pixel defect correcting film is positioned and attached to the surface of the liquid crystal display so that the refractive index varying area covers the black spots.

This liquid crystal display is controlled to make a red display, and appearance of the defective pixels is visually estimated before and after the attachment of the pixel defective correcting film. As a result, it has been found that when the pixel defect correcting film is attached, the black spots get slightly lighter and thus the defective pixels are hardly viewed as compared with the case where no film is attached.

### Example 2

(Formation of Refractive Index Varying Structure)

A film of epoxy resin of 35 μm in thickness was used as a color mura correcting film. A titan sapphire laser (wavelength: 785 nm, output: 10 mW, pulse width: 100 fs) was irradiated to this film to induce photo-polymerization through the multi-photon absorption reaction, thereby forming a spherical area of 150 nm in diameter whose refractive index was varied. Subsequently, the reaction was repeated while moving the laser irradiation area, and 10 arrays of spherical areas of 150 nm in diameter which were arranged at an interval of 200 nm period were formed in the range of 2 mm. The assembly of the 10 arrays was set as one set, and 100 sets were intermittently formed in the range of 2 mm, thereby forming the refractive index varying structure.

(Color Mura Correction of Image Display on Liquid Crystal Display)

In a commercially-available liquid crystal display device, visually recognizable blue color irregularities were generated as image data at a period of 2 mm in a 5 mm square on a display.

The color mura correcting film achieved according to the above method was attached to the color-irregularities portion on the display so that the periodic refractive index varying structure is coincident with the color irregularities. As a result, it was confirmed that the color irregularities were more inconspicuous than before the color mura correcting film was attached.

As described above, according to the present invention, by equipping the refractive index varying area on the defective pixel, the defective pixel of the image display can be corrected to be inconspicuous, and the product yield of the image display device can be enhanced.

In addition, according to the present invention, the color mura correcting film is equipped to the image display portion of the image display device and the complementary color of the color mura is generated in the color mura correcting film in connection with the color mura, whereby the color mura of the display image can be corrected to be inconspicuous, and thus the manufacturing yield of the image display device can be enhanced.

The entire disclosure of each and every foreign patent application from which the benefit of foreign priority has been claimed in the present application is incorporated herein by reference, as if fully set forth.

What is claimed is:

1. A pixel defect correcting method for image display, the method comprising:
equipping a refractive index varying area, which is different in refractive index from the surroundings thereof in a plane parallel to an image display face, on a defective pixel on the image display face.

2. A pixel defect correcting method for image display, the method comprising:
equipping a pixel defect correcting film on an image display face; and
equipping a refractive index varying area, which is different in refractive index from the surroundings thereof in a plane parallel to the image display face, to a portion of the pixel defect correcting film which is located above a defective pixel.

3. A pixel defect correcting method for image display, the method comprising:
attaching an image defect correcting film having a refractive index varying area, which is different in refractive index from the surroundings thereof in a plane parallel to a film face, onto an image display face so that the refractive index varying area is located above a defective pixel.

4. The pixel defect correcting method for image display according to claim 1, wherein the refractive index is varied by irradiating a laser beam to thereby equip the refractive index varying area.

5. The pixel defect correcting method for image display according to claim 2, wherein the refractive index is varied by irradiating a laser beam to thereby equip the refractive index varying area.

6. The pixel defect correcting method for image display according to claim 3, wherein the refractive index is varied by irradiating a laser beam to thereby equip the refractive index varying area.

7. An image display device, wherein a defective pixel of image display is substantially corrected by a refractive index varying area on an image display face which is different in refractive index from the surroundings thereof in a plane parallel to the image display face.

8. An image display device comprising:
a refractive index varying area which is different in refractive index from the surroundings thereof in a plane parallel to an image display face, the refractive index varying area being equipped above a defective pixel of the image display face.

9. An image display device comprising:
a pixel defect correcting film having a refractive index varying area, which is different in refractive index from the surroundings thereof in a plane parallel to an image display face, on the image display face, the refractive index varying area being located above a defective pixel of the image display face.

10. The image display device according to claim 9, wherein the pixel defect correcting film comprises photochromic material.

11. A color mura correcting method comprising:
equipping a color mura correcting film is equipped to an image display portion of an image display; and
correcting a color mura of a display image by the color mura correcting film,
wherein the complementary color of the color mura is generated in the color mura correcting film in accordance with the color mura of the display image.

12. The color mura correcting method according to claim 11, comprising:
equipping the color mura film with a refractive index varying structure which is periodically varied in refractive index and generates the complementary color of the color mura of the display image through light interference, whereby the complementary color of the color mura of the display image is generated in the color mura correcting film.

13. The color mura correcting method according to claim 12, wherein the refractive index varying structure is equipped by irradiation of a laser beam.

14. An image display device comprising:
a color mura correcting film for generating a complementary color of a color mura of a display image in accordance with the color mura, the color mura correcting film being equipped to an image display portion.

15. The image display device according to claim 14, wherein the color mura correcting film comprises a refractive index varying structure which is periodically varied in refractive index and generates the complementary color of the color mura of the display image through light interference.
